(19) United States
(12) Patent Application Publication
(10) Pub. No.: US 2013/0151371 A1
(43) Pub. Date: Jun. 13, 2013

(54) Systems and Methods for On-Line Clothing Rental

(71) Applicant: Mine for Nine, LLC, (US)

(72) Inventor: Marisa B. Moss, New York, NY (US)

(73) Assignee: Mine for Nine, LLC

(21) Appl. No.: 13/708,610

(22) Filed: Dec. 7, 2012

Related U.S. Application Data
(60) Provisional application No. 61/567,931, filed on Dec. 7, 2011.

(51) Int. Cl. G06Q 30/06

(52) U.S. Cl. CPC G06Q 30/0633
USPC 705/26.8

(57) ABSTRACT

A system, a method, and a computer program product for rental of items are disclosed. An item in the plurality of items can be selected. At least one parameter relating to the selected item and including at least a type of the selected item can be determined. A determination can be made whether a user desires to rent and/or purchase the selected item. If the user desires to rent the selected item, then at least one of the following determinations can be made: whether the selected item is available for rent, a desired rental period during which the selected item is rented out to the user, a rental cost of the selected item to the user based on the determined rental period, whether the user desires to extend the rental period of the selected item, and whether the user wishes to purchase the selected item after expiration of the rental period of the selected item. If the user desires to purchase the selected item, a purchase price of the selected item can be determined. The user can be authorized to rent and/or purchase the selected item and the selected item can be provided to the user.

### CROSS-REFERENCE TO RELATED APPLICATIONS

The present application relates to and claims priority to U.S. Provisional Patent Application No. 61/567,931 to Moss, filed Dec. 7, 2011, and entitled “Systems and Methods for On-Line Clothing Rental,” and incorporates its disclosure herein by reference in its entirety.

### TECHNICAL FIELD

The subject matter described herein relates to data processing and in particular, to providing systems and methods for on-line rental of various items, and more particularly, to rental and/or purchasing of various items.

### BACKGROUND

Clothing, shoes, accessories, and other items form a necessary part of one's wardrobe. Many different types of clothing may be used or required for different purposes, occasions, and events. Office work clothing can typically include variations of suits for both men and women. Inapposite of that, construction jobs can typically require special attire that protects one against various elements. Recreational activities, such as, attending theater, visiting a museum, participating in sporting events, or simply going out might not require clothing that one may wear to work.

Some types of clothing may be used only for a short period of time and likely not be used again in a future. Such limited-time and/or limited-use clothing may be appropriate for certain group of individuals. This group can include pregnant women. It is typical for a pregnant woman, as her body undergoes a change, to require different clothing sizes, shoe sizes, etc. during the course of the pregnancy. For example, clothing items that a pregnant woman wore during the first trimester of her pregnancy likely will not fit her during the third trimester of her pregnancy, thus, requiring the woman to obtain new items of clothing to wear during her third trimester.

Purchasing of new clothing can be very expensive. This can be aggravated by the fact that new items need to be purchased on a frequent basis and likely not reused again in the future. This is especially so for pregnant women. Since different size outfits (that might not be reusable in the future (e.g., after pregnancy)) are required by the pregnant woman at each stage of the pregnancy, expenses associated with purchasing new clothing items can quickly rise. Thus, there is a need to provide an ability for individuals to obtain clothing items on a less costly basis, such as by renting clothing items for a predetermined period of time.

### SUMMARY

In some implementations, the current subject matter relates to a computer-implemented method for rental of clothing and/or any other items. The method includes receiving a selection of items; determining at least one parameter relating to at least one of the following: type of items, at least one size of the items, color of the items, usage type, etc.; determine whether the user desires to rent or purchase the selected item; if the user desires to rent the item, determining whether the item is available for rent, determining a desired rental period during which the items is rented out to the user, determining the rental cost to the user based on the determined rental period, determining whether the user desires to extend the rental period, and determining whether the user wishes to purchase the selected item after expiration of the rental period; determining whether the user desires to purchase the selected item, and determining the purchase price of the item; authorizing the user to rent and/or purchase the selected item; providing the selected item to the user. The user can be configured to return a selected item of clothing after expiration of the rental period and/or renew the rental period and/or purchase the item.

In some embodiments, the current subject matter can be configured to include various features relating to determination of rental cost and purchase price, where the purchase price is determined based on the rental cost. The current subject matter can also provide a wait list feature that can allow a user to select a item that is currently unavailable for rental and/or purchase and add that item to user's wait list and request to be notified as to when the selected item becomes available. The current subject matter can also provide a wish list feature that can allow a user to select an item that is currently available for rental and/or purchase and add that item to user's wish list as one of the items that the user may desire to rent and/or purchase at a future time. The current subject matter can also include an ability to select one or more items and to combine them into a “package” that may or may not be rented and/or purchased at a discounted price. The current subject matter can also include a “shopping bag” feature that allows the user to select multiple items for rental and/or purchase. The current subject matter can also provide incentives to users and various additional features relating to gift cards, coupons, free gifts, free shipping, discounted shipping, other discounts, and/or other complimentary and non-complimentary options that can be made available to the user prior to, during, and/or after rental and/or purchase and/or any combinations thereof.

In some implementations, the current subject matter can be configured to allow rental and/or purchasing of clothing (e.g., maternity) accessories as well as other accessories (e.g., baby clothing and/or accessories). In some implementations, the current subject matter is not limited to rental and/or purchase of clothing items and can be used for rental and/or purchase of other items (e.g., sporting equipment, power equipment, entertainment equipment (e.g., stereos, audio equipment, musical instruments, etc.), multimedia equipment (e.g., televisions, DVD-players, etc.), communications equipment (e.g., telephones, smartphones, etc.), telecommunications equipment, vehicles, videos, movies, audio, toys, games (e.g., computer, non-computer related games, etc.), and/or any other items). In some implementations, the current subject matter system can be used to allow rental and/or purchase of accessories that can include at least one of the following: handbags, wallets, diaper bags, sunglasses, jewelry, infant's clothing items and accessories, and/or any other items.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for clothing rental/purchase, according to some implementations of the current subject matter;

FIG. 2 illustrates an exemplary system for clothing rental/purchase, according to some implementations of the current subject matter;

FIG. 3 illustrates an exemplary website system used in connection with system shown in FIG. 2, according to some implementations of the current subject matter;

FIG. 4 illustrates an exemplary method, according to some implementations of the current subject matter.

FIG. 5 illustrates an exemplary system, according to some implementations of the current subject matter.

### DETAILED DESCRIPTION

To address these and potentially other deficiencies of currently available solutions, one or more implementations of the current subject matter provide methods, systems, articles or manufacture, and the like that can, among other possible advantages, provide systems and methods for providing systems, methods, and computer program products for on-line clothing (or any other items) rental and/or purchase.

In some implementations, the current subject matter is not limited to rental and/or purchase of clothing items and can be used for rental and/or purchase of other items (e.g., sporting equipment, power equipment, entertainment equipment (e.g., stereos, audio equipment, musical instruments, etc.), multimedia equipment (e.g., televisions, DVD-players, etc.), communications equipment (e.g., telephones, smartphones, etc.), telecommunications equipment, vehicles, videos, movies, audio, toys, games (e.g., computer, non-computer related games, etc.), and/or any other items).

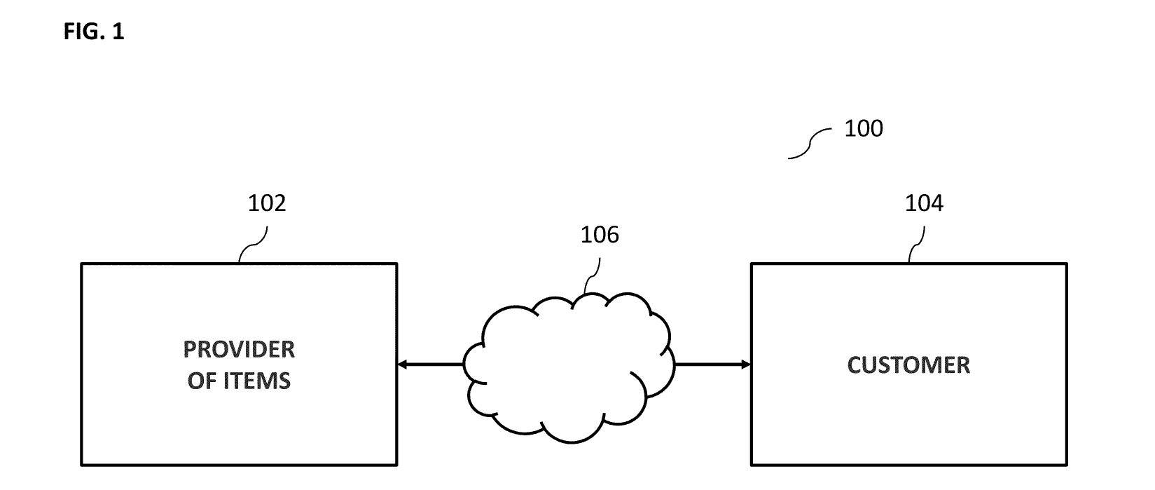

FIG. 1 illustrates an exemplary system 100 for providing clothing rental and/or purchase, according to some implementations of the current subject matter. The system 100 can be implemented in any communication system, including the Internet, an internal network, an external network, and/or any other network. The system 100 can implement usage of wired, wireline, wireless computing devices, and/or any other devices, and/or any combination thereof. The devices can include, but are not limited to, a personal computer, a laptop computer, a smartphone, a cellular telephone, a tablet, a graphical tablet, a personal digital assistant (“PDA”) device, an iPhone®, an iPad®, an iPod®, and/or any other device or combination of devices. The devices can be operated by entering appropriate commands through the input/output devices of the above device (e.g., typing using a keyboard, clicking an icon on a screen corresponding to a command, touching a location corresponding to a command on a touchscreen, as well as by any other means). The operation(s) associated with the current subject matter's system can be implemented by typing commands in a computer prompt, moving a mouse cursor or performing any other operation using various methods including, but not limited to, a joystick, a mouse, a keyboard, etc., using finger(s) (e.g., such as in the case of an iPad, iPod, iPhone, etc. and/or any other touch screen device), a stylus tool, and/or using any other methods and/or combination of methods.

The system 100 can include a provider of clothing items 102 and at least one customer 104 communicating through a communications network 106. The provider of clothing items 102 and the customer 104 can communicate via the communications network 106 using various electronic media, email, World Wide Web, and/or any other way, and/or any combination of ways. The communications network 106 can include at least one of the following: the Internet, an internal network, an external network, metropolitan area network (“MAN”), local area network (“LAN”), wide area network (“WAN”), and/or any other network, and/or any combination of networks. Using the network 106, the customer 104 can contact the provider 102 to request rental of clothing items (and/or any other items) and/or purchase of clothing items and/or a combination of both. The customer 104 can request rental of a clothing item for a predetermined period of time (e.g., a day, a week, a month, a year, and/or any other period of time) and then return the item after expiration of that predetermined period of time. The customer 104 can also request a purchase of the rented item from the provider 102 after expiration of the predetermined period of time. The customer 104 can also purchase of the item without rental of the item from the provider 102. The customer 104 can also request the provider 102 to place selected items on a “wish list”, whereby the customer 104 can determine whether or not to rent, purchase, and/or rent and purchase at a predetermined time (e.g., within a day, a week, a month, etc.). The customer can also request the provider 102 to place selected items on a “wait list”, whereby the customer 104 can desire to rent, purchase, and/or rent and purchase the selected items, but at the time of customer's desire such items are not yet available for renting, purchasing, and/or renting and purchasing from the provider, wherein the customer can request the provider to notify the customer when the selected items become available.

The provider 102 can include a system that can determine customer's selections of items, whether customer 104 wants to rent, purchase, and/or both, ascertain rental period, determine rental price (e.g., based on the item, selected rental period, popularity of the selected item, availability of the selected item, customer's profile, and/or any other factors and/or any combinations thereof), ascertain purchase price (if any), provide an incentive to the customer, etc. The provider 102 can also perform necessary cleaning of the items when they are returned after expiration of rental periods. The provider 102 can also include a warehouse that can store items that can be made available for rental and/or purchase. The provider 102 can also include a conventional customer service system that can provide assistance to customer 104 (such assistance can be provided via the network, via telephone, and/or any other means).

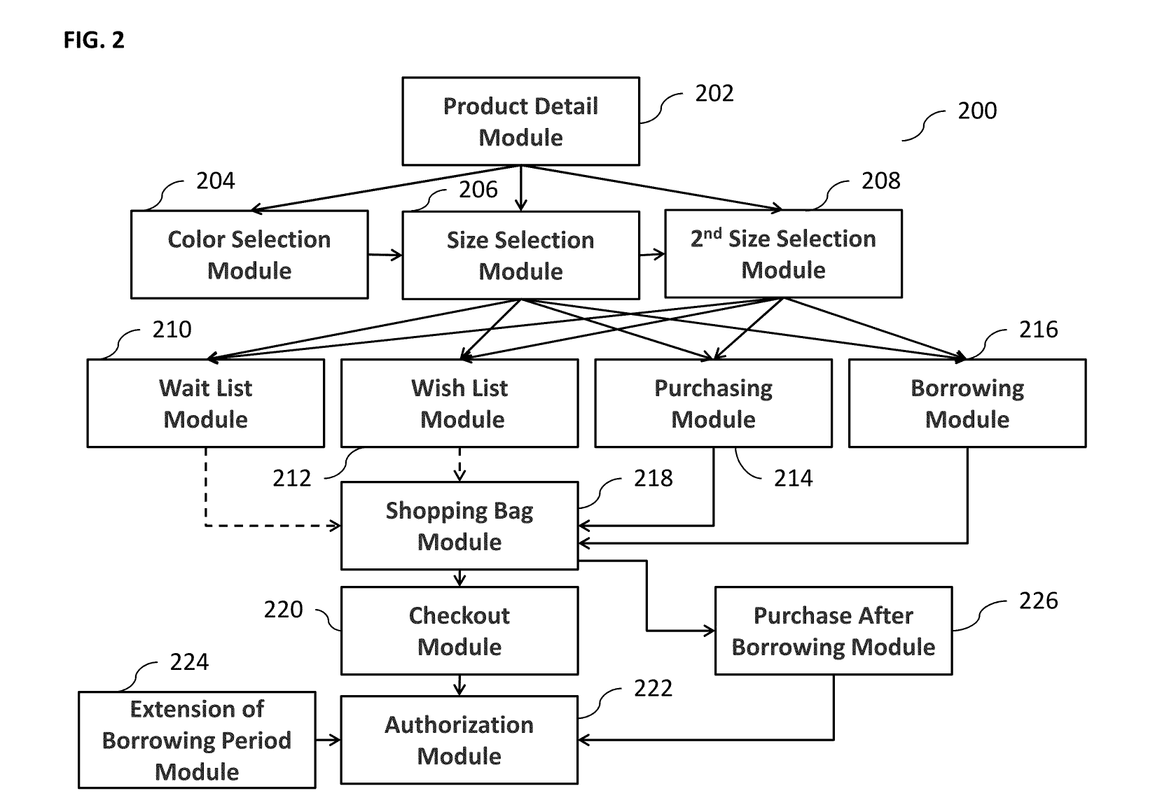

FIG. 2 illustrates an exemplary provider computing system 200 that can be used for rental and/or purchasing of items by the customer 104 (not shown in FIG. 2), according to some implementations of the current subject matter. The system 200 can be implemented in a website that can operate in the World Wide Web (or Internet and/or any other network discussed above). The system 200 can include a product detail module 202, a color selection module 204, a size selection module 206, a second size selection module 208, a wait list module 210, a wish list module 212, a purchasing module 214, a borrowing module 216, a shopping bag module 218, a checkout module 220, an authorization module 222, an extension of borrowing period module 224, and purchase after borrowing module 226. One or more of these modules can be implemented in software and/or hardware system that can include at least one processor for executing at least one of these modules. The system can also include a customer user interface (which can be a website operating in the World Wide Web) (not shown in FIG. 2), using which the user can enter various commands that can be performed by the modules shown in FIG. 2.

In some implementations, execution of the product detail module 202 can be configured to provide a user interface (e.g., a website) for the customer with various product details, including information about clothing items, i.e., what they are (e.g., a dress, a top, a skirt, jeans, etc.). The module 202 can include a listing of items on the user interface (e.g., website) from which the user can select particular items of interest. Once a customer 104 (not shown in FIG. 2) has selected a particular item of interest, the product detail module 202 can be configured to interact with color selection module 204, the size selection module 206, and optionally with second size selection module 208. These modules can be triggered upon customer's selection of a particular item from the user interface. Thus, when an item of clothing is selected, the system 200 can prompt the customer to select color, size, and/or any other optional sizes (for example, a dress, having a red color, and size medium).

In some implementations, the customer 104, upon selecting a clothing item, having a particular color and size, can also utilize the wait list module 210 and/or wish list module 212. The module 210 can allow the customer to place a desired item that might not be available for immediate rental and/or purchase from the provider 102 (not shown in FIG. 2) on a wait list, whereby, upon availability of the item from the provider 102, the customer 104 can be provided with the desired item. The customer can place at least one item on the wait list. The wish list module 212 can allow the customer 104 to place items that may or may not be immediately available from the provider 102 for rental and/or purchase on a list of items that the customer may desire to rent and/or purchase but is not certain whether the customer wants to rent and/or purchase the item right away. The wait list and/or wish list items can be later on directly added to a shopping bag module 218 for processing purposes (e.g., payment, etc.). Alternatively, these items can be processed by the purchasing module 214 and/or the borrowing module 216 depending on the desire of the customer 104.

Once the desired item has been identified by the customer, its color and size and/or any other attributes are identified, the system 200 can be configured to execute either the purchasing module 214 and/or the borrowing module 216 depending on the desire of the customer and the availability of the desired item. The purchasing module 214 can allow the customer to purchase the item from the provider 102 for the price listed on the user interface. The borrowing module 216 can allow the customer to rent the desired item from the provider 102 for a predetermined period of time upon payment of an appropriate rental fee that is indicated on the user interface.

The item(s) processed by the purchasing module 214 and/or the borrowing module 216 can be added to the shopping bag module 218. The customer may choose to pay for all or some items in the shopping bag module 218 during a checkout and payment procedure performed by a checkout module 220. The customer can use any form of payment to pay for the items in the shopping bag module 218. Once the checkout and payment procedures are completed, the authorization module 222 performs various authorization procedures that can allow further processing and shipment of the items selected by and paid for by the customer.

The customer can also be given an option to purchase items after the customer borrowed them for a predetermined period of time. For example, the customer 104 borrowed a particular clothing item for a period of one month and has decided that the customer would like to keep the item permanently after expiration of the rental period. The purchase after borrowing module 226 can be configured to provide the customer to purchase the rented item after expiration of the rental period. The system 200 may determine whether the item selected by the customer can be available for purchase after rental. Such determination can be based on various factors including but not limited to, uniqueness of selected item, inventory of the selected item, age of the item, consumer demand, availability of item in the market place, and/or any other factors. The system 200 can also determine the purchase-after-rental price for the item, which may be discounted by various factors, including the rental fee that the customer has already paid for the item. Once the customer is permitted to purchase the item, the authorization module 222 can be configured to permit the customer to keep the item after processing an appropriate payment.

In some implementations, the customer can be permitted to extend the rental period of the selected item. This can be processed by module 224. The customer can contact the system 200 and request an appropriate extension of the initial borrowing period of the selected item. The customer can request an extension for any predetermined period of time. Alternatively, the system 200, through module 224, can limit the predetermined period of time and/or number of times that the customer can extend the initial borrowing period.

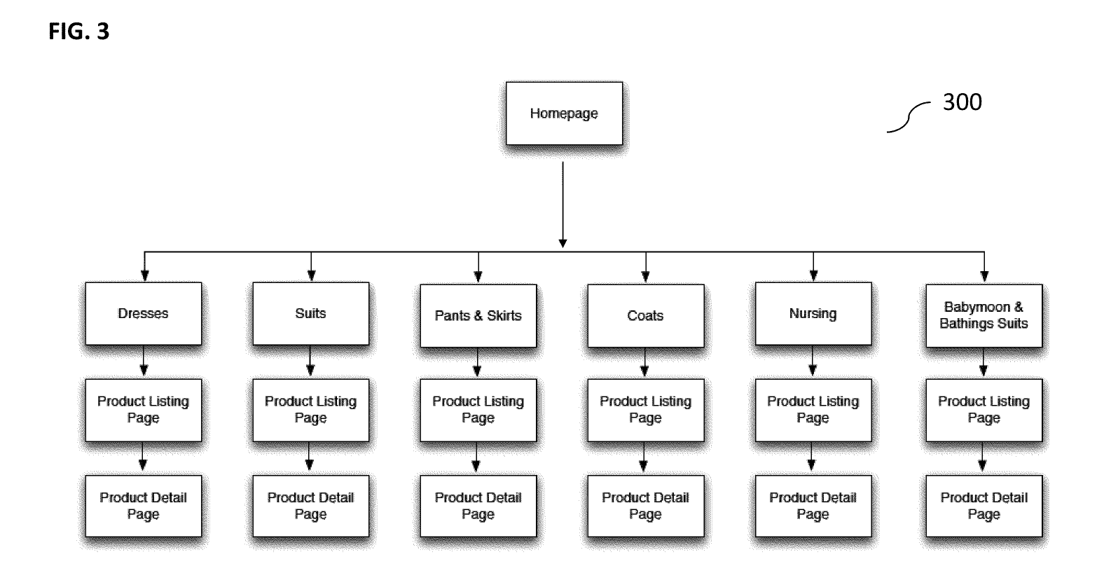

FIG. 3 illustrates an exemplary website or homepage hierarchy 300 that include a plurality of exemplary clothing categories that can be made available to the customer 104 by the provider 102. As shown in FIG. 3, the various exemplary categories include but are not limited to, “Dresses”, “Suits”, Pants & Skirts”, “Coats”, “Nursing”, “Babymoon & Bathing Suits”, etc. Each category can include a corresponding product listing page that can provide a user interface (e.g., a website) containing a list available items in each category and a corresponding product detail page (e.g., another website) that can provide the customer with specific details about an item selected from the product detail page (e.g., color, size, price, availability, etc.).

The following illustrates details of various user interfaces that can be provided to the customer by the system 200 and its corresponding modules. The user interfaces can include at least one of the following: a customer interface, a product catalog interface, a report interface, and various inventory management interfaces. Each of these is discussed in further detail below.

### I. Customer Interface

In some implementations, the customer interface can include an order list screen, a customer order page, and a change status section. In some implementations, the customer order information can be maintained in the order list screen interface. The order list screen can provide information about the order. The information can include at least one of the following, order number, first and last names of the customer, status, products cost value, shipment cost, applicable tax, total cost value of the order, date/time of the order, payment type, shipping information (including different shipping options: overnight, two-day, etc.), date set (whether or not the return date for borrowed clothing has been established), postage (whether or not the return postage label has been uploaded), and/or other information. The order page can allow sorting by any of the above categories of information. Searches and/or sorting within each specific category (name, order, number, time, etc.) identified above can also be accomplished. The status of the order can include at least one of the following: confirmed (order has been received and confirmed by a credit card processor), sent (order has been mailed to customer), dry cleaning (order has been returned and the items are currently being cleaned by a dry cleaning service of the provider 102), closed (orders that have been finished and there are no other items outstanding), canceled (order was canceled).

In some implementations, the customer order page can include a user interface that can provide various options that can be utilized by the customer 104 and/or user associated with the provider 102. In the following discussion, unless specifically noted, the term “user” will refer to the customer 104 and/or user associated with the provider 102. For example, the user can edit the order using a plurality of tabs that can appear on the user interface. The following is a discussion of some exemplary tabs that can be included in the customer order user interface. An extra item tab can allow the user to add an item onto customer's order that was not in the original order. For example, a customer decides she wants the “Deluxe Short Satin Dress”, which was not in her original order. The new item can be added to the original order by clicking on the extra item tab. The provider 102 can be configured to send a notification or confirmation to the customer upon addition of new items. The notification can include customer's order tracking information, shipping directions, pictures and/or description of the items in the order, size, color, SKU, quantity, type (rental/purchase), rental period, unit price, etc. Customer's invoice can be included with the notification and can indicate if an item is a second size is available for free to the customer, delivery method, billing directions, total breakdown of products, shipping costs, taxes, and/or discounts, etc.

The customer page interface can also include a returned clothing tab. This tab can allow for generation of an automated e-mail that the customer can receive when customer's clothing item is returned. The damaged clothing tab can include a template e-mail when clothing item is received back from a customer and is damaged. A refund e-mail tab can include a template e-mail that can be customized when a customer returns clothing which requires a refund. A return overdue tab can include a template e-mail that can be customized when a customer has not yet returned clothing after expiration of the predetermined rental period and the customer can be charged another rental fee for another predetermined period of time. An uploaded label tab can indicate what return postage labels have already been uploaded.

In some implementations, the customer page user interface can allow the user to edit the order. The user interface can also show the history of the order. It can also include at least one of the following: order number, customer's e-mail address, shipping method, payment method, number of orders from the customer, total order value, last five orders from the customer, baby's gender, where the customer heard about the provider, customer's shipping address and billing addresses, etc. The user interface can include an order section that can list items ordered by the customer and can include at least one of the following: product, borrow status, style (color and size), order type, a unique provider identifier code, quantity, insurance—an optional election of $X per item, period—the rental period, unit price, total price, etc. The system 200 can also calculate invoice total of the value of products, the shipping (based on the customer's election) and taxes, and if applicable to get a “grand total” for the invoice.

In some implementations, the user can be provided with an additional functionality in the order section to add, delete and/or swap an item from the customer's order. To add an item, the user can enter an SKU to find the availability to borrow and/or purchase an item. To delete an item, the user can click on an “x” sign next to the item and the item can be deleted from the order. To swap an item, the user can click on an item to be swapped and an icon for swapping that can prompt the system 200 to bring up a window requesting the customer to enter an SKU of an item currently in the inventory for swapping purposes it.

In some implementations, the user can change status of the customer's order. The options for status can include providing a new status (e.g., “Confirmed” (order has been received and confirmed), “Sent” (Order has been mailed), “Dry Cleaning” (Order has been returned and the items are currently at the dry cleaning services of the provider), “Closed” (Orders that have been finished and there are no other items outstanding), “Cancelled” (Order was canceled)).

The system 200 can also provide tracking information for the order, ability to view and print the invoice for the items ordered, send confirmation correspondence (e.g., email), set a return date for the item(s) that have been rented by the customer, confirmation of delivery of the rented item(s), generate and/or print a return postage label that the customer can use to return the rented item(s), and/or any other options.

In some implementations, when a customer's order has been delivered, the system 200 can be configured to initiate a clock that can indicate when the customer's rented items may be due for a return. The clock for the return date can start on the date on which the order is delivered to the customer (as opposed to for example, the date it was shipped). Alternatively, the system can initiate the clock from the date the rented items were shipped. In some implementations, the return dates can be calculated automatically based on an indication from a delivery service that customer's rented items have been delivered to and/or accepted by the customer. The rental period can be any number of days, weeks, months, etc. and/or any combination thereof. In some implementation, the system can be configured to automatically generate a notification (e.g., a reminder email) or multiple notifications (e.g., at different times (e.g., a week before, a day before, etc.)) that can include a listing of dates by which an item needs to be shipped.

In some implementations, the customer can have already returned several rented items, but has decided that she would like to keep a particular item in the original order rented for at least another predetermined period of time (e.g., another month). The system 200 can allow a reset of the return date that was originally specified in the order. The customer can access the website of the provider and alert the provider that the return date for at least one item in the original order needs to be reset. The system 200 can calculate a new return date based on the notification from the customer. The new return date can be based on the date that the customer notified the provider that the customer would like to continue renting the item. New delivery date can be used to calculate the return date. The same prompts can come up asking the user at the provider 102 if the user would like to send the customer an e-mail with the return date. If the return date is extended, the user at the provider 102 can indicate in the affirmative and alert the customer when the item must be mailed again.

In some implementations, the system 200 can be configured to provide provider's inventory tracking system capabilities. The system can be set up to provide an update inventory depending on if the customer returns the item as planned, whether or not the item has to be dry cleaned and/or whether the customer decides to buy it after renting the item. The following is a discussion of how to the inventory is updated based on various events associated with rental of items by the customer. If the customer decides to purchase the item after borrowing it, the system can prevent the item from being put back into the provider's inventory and instead, indicate that the customer purchased the item. If the customer returns item and it does not need to be dry cleaned (e.g., it was not worn by the customer, and/or was a second size free option), the system 200 can determine whether the customer purchased the item. If not, then the system 200 can determine whether the item needs to be dry cleaned. If not, then the item can be put back into the provider inventory. If the customer returns item and it needs to be dry cleaned, then the system 200 can determine whether the customer purchased the item. If not, then the system can determine whether the item needs to be dry cleaned. If yes, then the system can request dry cleaning of the item by a dry cleaning service that may be associated with the system 200. The customer's invoice can also be updated to show that the particular item is at the dry cleaners. The system can notify the customer that the item was received by the provider. The system 200 might not add the item back to inventory as it needs to be dry cleaned. Once the item has been received back from the dry cleaning service, the system can determine whether to add the item back into the inventory. If the customer decides to purchase the selected item outright, then the system 200 can generate an appropriate payment request form and request the customer to submit payment for the selected item. In some implementations, the customer can be charged automatically (e.g., charge customer's credit card account that may be stored by the provider 102, customer's bank checking account that may also be stored by the provider 102, and/or any other form of payment method) for the rental and/or purchasing of items.

### II. Product Catalog

The product catalog can include a database of provider inventory. It can be stored in the memory system associated with the system 200. The catalog can include clothing categories, colors, designers, icons, product banners and/or promotions for any items. The product catalog can include at least one of the following sections: products, products categories, product colors, designers of products, promotions, and/or any other categories. The product list can allow searching by product name, category (e.g., tops, bottoms, jeans, suits, babymoon, etc.), code (e.g., a unique SKU identifier), status (e.g., active, inactive, etc.), and season (e.g., season in which the provider purchased the items). The current subject matter can also provide a products detail page that can include each item's individual SKU and item's own product details interface. In some implementations, the product details interface can include at least one of the following different sections: product categories, product attributes, search engine optimization, and product image gallery. The product categories, the customer of the provider can be provided with an ability to view a particular item in a selected color. The customer can also be provided with an indication that a certain clothing item can be available for purchase only. This means that an item selected by the customer can only be purchased and not available to be borrowed. On the listing page, the system 200 can exclude the borrow price. Additionally, the system 200 can only make a certain item available for purchase only on the details page about a particular item. In some implementations, the system 200 can also allow the customer to select which categories the customer would like an item to be displayed in. The item can be displayed in several different categories, for example, suit pants can go in the suits category and the bottoms category as well.

In some implementations, the items can have various product attributes. The product attributes can be used to search for an item using system 200. The product attributes can include at least one of the following: product names of the items (e.g., the name of product), unique identifier codes for the items (e.g., the unique SKU assigned the item), color of items (e.g., color categories can be created and defined by the system 200), designer of items (e.g., designer categories can be created and defined by the system 200), borrow period of items (e.g., one week/two weeks/three weeks, two weeks/four weeks/six weeks, one month/two months/three months, etc., and/or any combination thereof), description of the items, fabric information (e.g., description of the fabric content of the items), washing instructions for the item (e.g., description of the washing instructions for the item (dry clean only, wash with bleach, etc.)), price of the items (which can include a retail price, a borrow price, and/or any other price), status (e.g., if an item is inactive, it will not show up on the customer interface), recommended products section (e.g., items can be shown that may be similar to or otherwise related to the item selected by the customer (i.e., as “items you may also like”)), new item indication (e.g., the system 200 can indicate whether the item has been recently added to provider's inventory and hence, is new), season when items were purchased (e.g., spring, summer, etc.).

In some implementations, the system 200 can also provide for an optimized searching for items to customers. The items can be searched by item identifiers, colors, product categories, season, whether the item is new or not, and/or using any other keywords. Upon entry of a keyword by the customer, the system 200 can attempt to locate a particular item and/or items and display it to the customer in response to the search query containing the keyword.

In some implementations, the system 200 can also be configured to offer various promotions to the customers for at least one item (whether or not such item is selected by the customer). For example, a promotion can be offered to the customer allowing for a 10% discount on specific items that may relate to an item selected by the customer (e.g., a 10% discount on blouses based on a particular pair of trousers being selected).

### III. Reports

The system 200 can also be configured to generate various reports relating to activities of the system 200 and its customers. The reports can include at least one of the following: an abandoned shopping cart report, a borrow status report, a disabled products report, a dry cleaning report, an out of stock report, a products report, a sales report, a wish list report, and/or any other reports. The abandoned shopping cart report can indicate how many customers put items in their shopping cart, but did not follow through with the checkout process. The borrow status report can indicate customers that have items outstanding (i.e., rented but not returned) and when they are being scheduled to be returned. The report can be sorted by return date, customer, item, order date, and/or any other parameter. It can also have search functionality as well. The disabled products report can indicate which items have sizes that have been disabled (i.e., not available to customers for rent and/or purchase). The dry cleaning report can indicate items that are currently at the dry cleaning service. The report can include search and sort functionality that can allow searching through and/or sort each column in the report. It should be noted that all reports can include such functionalities along with any others. The out of stock report can indicate which items are out of stock and hence are not available for rental and/or purchase by customers. The report can distinguish between out of stock items for sale (i.e., items are available for rental and/or purchase at regular price but not available for rental and/or purchase at a sale price) and out of stock items for rental and/or purchase at any price. The products report can provide an in stock inventory of items that can be available for rental and/or purchase either a sale price and/or regular (non-sale) price. The report can be broken down by categories of clothing. The sales report can summarize sales on a daily, weekly, monthly, yearly basis, and/or any other basis. The wish list report can include both wish list and wait list items. The wish list report can indicate which customers have placed item(s) on their wish lists. The waitlist report can indicate how many customers included item(s) on their waitlist (e.g., because the item is currently out of stock). When an item is returned to inventory, a customer can receive a notification stating that the item is now back in stock and can be ordered (for rental and/or purchase).

In some implementations, the reports can be stored in a database that can be associated with the provider 102. The reports can also be formatted in any desired interface using conventional programs (e.g., Microsoft Excel, and/or any other programs).

### IV. Inventory Management

In some implementations, the current subject matter can provide inventory management functionality to the provider of items. The inventory management functionality can indicate at least one of the following:
What sizes are available for each item in the provider inventory (e.g., extra small, small, medium, large, extra-large, etc.);
How many items the provider has in each size that can be sold;
How many items the provider has in each size that can be borrowed;
Identifier information for each item in each size and/or color;
Weight information (e.g., weight of the item, which can be used for example to calculate shipping charges).
Status that can indicate whether a particular size is available for rental, purchase, and/or both
   If a size is “inactive,” then the item's inactive size cannot be selected for rental, purchase, and/or both;
   If a size is “active,” but the provider does not have any in stock in a particular size, that size of the item will show up on the details page of the front end of system, but customer may be prevented from selecting that item in that size.

In some implementations, each individual size of an item can have its own detailed page or interface that can be viewed by the customer. The customers viewing items' pages/interfaces can be provided with a size chart functionality, where the customer can either enter customer's size for a particular item and/or be guided to select a particular size based on a size chart. The provider can input the measurements of a particular piece of clothing so that the customer can select a particular size for the item. Depending on the item, the provider can measure different parts of the clothing items: bust: tops, blazer, dresses, coats; back: tops, blazer; hips: dresses, pants; length: dresses, coats; inseam: pants, skirt, and/or any other parts. These measurements can be indicated by the system 200 to the customer (e.g., on the provider's website) when a customer selects on “clothing measurements” on the details page relating to a selected clothing item.

In some implementations, the customer can also enter her own measurements that can relate to customer's height, waist size, hip size, etc. Based on these measurements, the system can determine what the customer's size can be or should be for each particular item of clothing (e.g., small, medium, large, etc.).

In some implementations, the system 200 can update the inventory when an item is removed from an invoice or an order entered by the customer and/or is being canceled. When this happens, the system 200 can provide an option to add it back to rental and/or purchase stock of items.

In some implementations, the system 200 can also provide discounts to customers. For example, the system can offer an option to send a 10% off coupon email to each customer from their invoice. The 10% off coupon can be linked to a particular email address of the customer so that it can only be used once.

In some implementations, the system 200 can also allow to change a price (rental and/or purchase) on a customer's order for any and/or all of the items.

In some implementations, the provider's inventory can indicate what items are available, in what sizes, colors, etc. The inventory can also indicate whether any of the items are out of stock, available for rental, available for purchase, available for rental and/or purchase, available for purchase after rental, etc. The inventory can also indicate what items have been borrowed and when they are due for a return. The inventory can also show whether the customer borrowed an item for what period and/or whether the customer requested and/or received an extension of the return period. Additionally, the inventory can be indicative of the prices paid and/or any discounts applied to rental and/or purchase of items.

In some implementations, the inventory can be stored in a table and/or a database that can be stored in a memory location. The inventory can be updated automatically and/or manually upon detection of a rental, purchase, return from the customer, extension request/grant, items being sent to and/or returned from dry cleaning service, and/or any other events. The inventory can also have a separate borrow inventory (indicative of items borrowed) and a purchase inventory (indicative of items purchased). For example, when an item is returned to the inventory after the customer rental period expired, the borrow inventory can be updated but the purchase inventory will not be updated. When a customer borrows an item, the item can be removed from the borrow inventory and the purchase inventory. This process can occur until there are no more items in purchase inventory. If an item is purchased, the item can be removed from the purchase inventory only.

In some implementations, the provider can determine whether the item has been returned after expiration of the rental period and whether a dry cleaning service is necessary. If the item requires dry cleaning, it can be sent to the dry cleaning service. While the item is being dry cleaned, the inventory might not be updated to indicate that the item is available. Alternatively, the inventory can be updated to indicate that the item has been returned from the customer. Once the item is in physical possession of the provider, the item can be added back to the inventory (purchase inventory and/or borrow inventory). For example, when an item is purchased, but customer returns it unused, then it can be made available for rental and/or purchasing. When a customer returns the item whether after submitting a request to borrow and/or to purchase it, the provider can check the item for any defects and determine customer's reason for return. Based on the reason for return, the provider can determine whether or not to add the item to inventory (whether borrow inventory and/or purchase inventory).

In some implementations, the provider can identify the items through use of various labels, bar coding, heat scanned labels, and/or any other methods to check in and out items in its inventory.

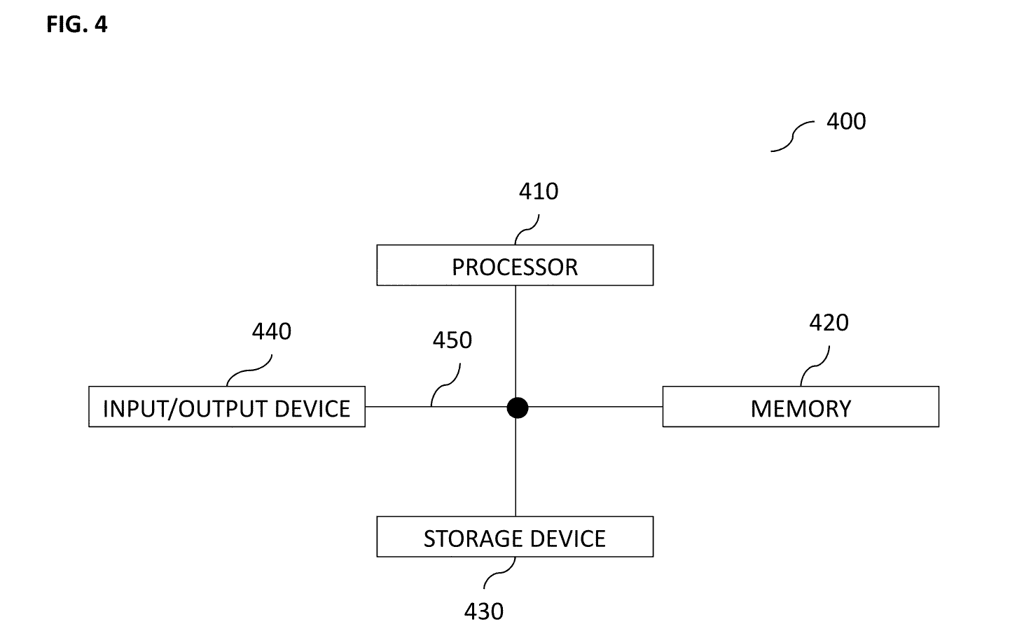

In some implementations, the current subject matter can be configured to be implemented in a system 400, as shown in FIG. 4. The system 400 can include a processor 410, a memory 420, a storage device 430, and an input/output device 440. Each of the components 410, 420, 430 and 440 can be interconnected using a system bus 450. The processor 410 can be configured to process instructions for execution within the system 400. In some implementations, the processor 410 can be a single-threaded processor. In alternate implementations, the processor 410 can be a multi-threaded processor. The processor 410 can be further configured to process instructions stored in the memory 420 or on the storage device 430, including receiving or sending information through the input/output device 440. The memory 420 can store information within the system 400. In some implementations, the memory 420 can be a computer-readable medium. In alternate implementations, the memory 420 can be a volatile memory unit. In yet some implementations, the memory 420 can be a non-volatile memory unit. The storage device 430 can be capable of providing mass storage for the system 400. In some implementations, the storage device 430 can be a computer-readable medium. In alternate implementations, the storage device 430 can be a floppy disk device, a hard disk device, an optical disk device, a tape device, non-volatile solid state memory, or any other type of storage device. The input/output device 440 can be configured to provide input/output operations for the system 400. In some implementations, the input/output device 440 can include a keyboard and/or pointing device. In alternate implementations, the input/output device 440 can include a display unit for displaying graphical user interfaces.

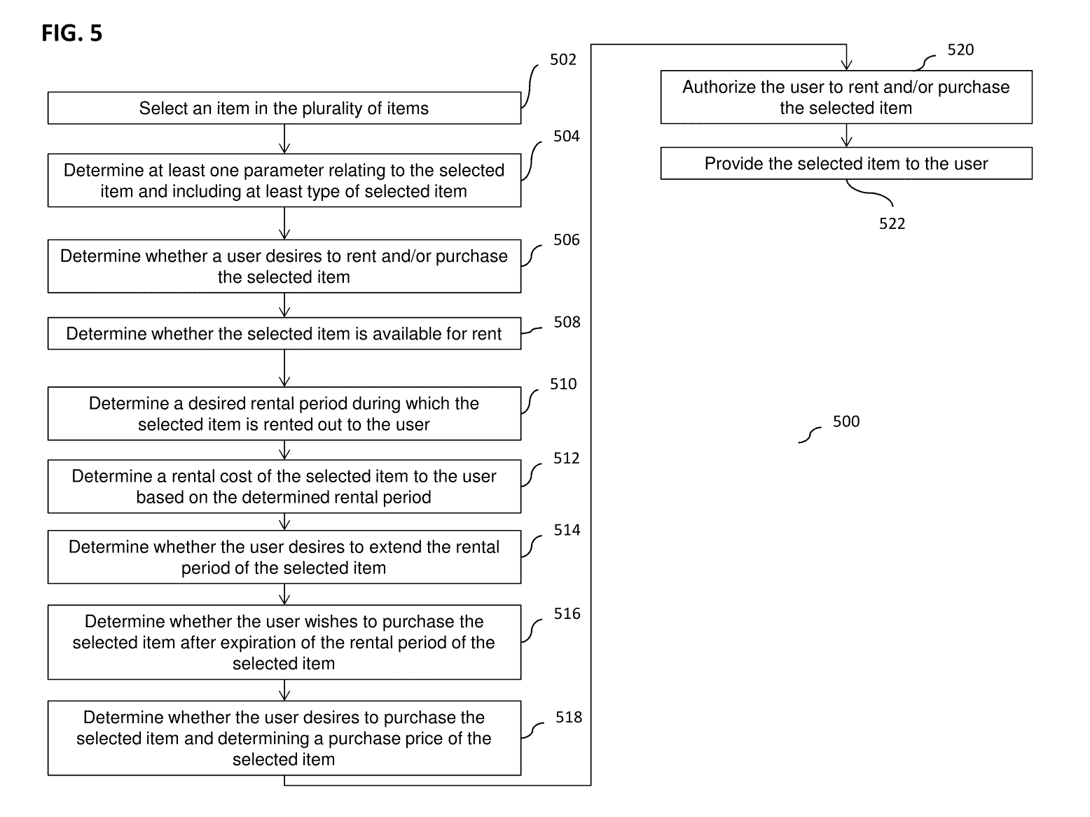

FIG. 5 illustrates an exemplary method 500, according to some implementations of the current subject matter. At 502, a selection of clothing can be received. At 504, at least one parameter relating to at least one of the following: type of clothing, at least one size of the clothing, and color of the clothing can be determined. At 506, a determination can be made whether the user desires to rent or purchase the selected clothing. At 508, if the user desires to rent the clothing, determination can be made whether the clothing is available for rent. At 510 a desired rental period during which the clothing can be rented out to the user can be determined. At 512, the rental cost to the user can be determined based on the determined rental period. At 514, a determination whether the user desires to extend the rental period can be made. At 516, a determination whether the user wishes to purchase the selected clothing after expiration of the rental period can be made. At 518, a determination can be made whether the user desires to purchase the selected clothing and the purchase price of the clothing can be determined. At 520, the user can be authorized to rent and/or purchase the selected clothing. At 522, the selected clothing to the user can be provided to the user. The user can be configured to return a selected item of clothing after expiration of the rental period and/or renew the rental period.

In some embodiments, the current subject matter can be configured to include at least one of the following optional features. A determination of rental cost and purchase price, where the purchase price is determined based on the rental cost can be made. The current subject matter can also provide a wait list feature that can allow a user to select a clothing item that is currently unavailable for rental and/or purchase and add that clothing item to user's wait list and request to be notified as to when the selected item becomes available. The current subject matter can also provide a wish list feature that can allow a user to select a clothing item that is currently available for rental and/or purchase and add that clothing item to user's wish list as one of the items that the user may desire to rent and/or purchase at a future time. The current subject matter can also include an ability to select one or more clothing items and to combine them into a “package” that may or may not be rented and/or purchased at a discounted price. The current subject matter can also include a “shopping bag” feature that allows the user to select multiple clothing items for rental and/or purchase. The current subject matter can also provide incentives to users and various additional features relating to gift cards, coupons, free gifts, and other complimentary and non-complimentary options that can be made available to the user prior to, during, and/or after rental and/or purchase.

In some embodiments, the current subject matter can be configured to allow rental and/or purchasing of clothing (e.g., maternity) accessories as well as other accessories (e.g., baby clothing and/or accessories). In some implementations, the current subject matter system can be used to allow rental and/or purchase of accessories that can include at least one of the following: handbags, wallets, diaper bags, sunglasses, jewelry, infant's clothing items and accessories, and/or any other items.

In some implementations, as stated above, the current subject matter is not limited to rental and/or purchase of clothing items and can be used for rental and/or purchase of other items (e.g., sporting equipment, power equipment, entertainment equipment (e.g., stereos, audio equipment, musical instruments, etc.), multimedia equipment (e.g., televisions, DVD-players, etc.), communications equipment (e.g., telephones, smartphones, etc.), telecommunications equipment, vehicles, videos, movies, audio, toys, games (e.g., computer, non-computer related games, etc.), and/or any other items). The system can provide the customer with an ability to select various items based on the items attributes (e.g., size, color, functionality, ability, purpose, price, etc.) and determine whether the customer would like to rent a selected item, determine a period of time during which the customer wishes to rent the item, pay for the item and have the item shipped/delivered to the customer for use during the determined period of time. The customer can also be provided with an ability to extend the rental period, purchase selected item either outright and/or after the expiration of the rental period. The current subject matter system can provide the customer with some or all of the functionalities that have been discussed above with regard to rental of clothing. As can be understood, the current subject matter system can be used to perform the operations discussed above irrespective of the specific items being rented and/or purchased.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer implemented method, comprising:
selecting an item in the plurality of items;
determining at least one parameter relating to the selected item and including at least a type of the selected item;
determining whether a user desires to rent and/or purchase the selected item;
if the user desires to rent the selected item,
determining whether the selected item is available for rent,
determining a desired rental period during which the selected item is rented out to the user,
determining a rental cost of the selected item to the user based on the determined rental period,
determining whether the user desires to extend the rental period of the selected item, and
determining whether the user wishes to purchase the selected item after expiration of the rental period of the selected item;
determining whether the user desires to purchase the selected item and determining a purchase price of the selected item;
authorizing the user to rent and/or purchase the selected item; and,
providing the selected item to the user.

2. The method according to claim 1, further comprising
performing at least one of the following: returning the selected item after expiration of the desired rental period and renewing the desired rental period.

3. The method according to claim 1, wherein the purchase price is determined based on the rental cost.

4. The method according to claim 1, further comprising
generating a wait list to allow the user to include the selected item that may be currently unavailable for rental and/or purchase;
adding the selected item to generated wait list;
requesting a notification indicating when the selected item is available.

5. The method according to claim 1, further comprising
generating a wish list to allow the user to include the selected item that is currently available for rental and/or purchase;
adding the selected item to the generated wish list as an item that the user may wish to rent and/or purchase at a future time.

6. The method according to claim 1, further comprising
selecting one or more items in the plurality of items;
combining the selected one or more items into a package for rental and/or purchase at a first price.

7. The method according to claim 1, further comprising
providing an incentive to the user to rent and/or purchase the selected item.

8. A computer program product comprising a machine-readable medium storing instructions that, when executed by at least one programmable processor, cause the at least one programmable processor to perform operations comprising:
selecting an item in the plurality of items;
determining at least one parameter relating to the selected item and including at least a type of the selected item;
determining whether a user desires to rent and/or purchase the selected item;
if the user desires to rent the selected item,
determining whether the selected item is available for rent,
determining a desired rental period during which the selected item is rented out to the user,
determining a rental cost of the selected item to the user based on the determined rental period,
determining whether the user desires to extend the rental period of the selected item, and
determining whether the user wishes to purchase the selected item after expiration of the rental period of the selected item;
determining whether the user desires to purchase the selected item and determining a purchase price of the selected item;
authorizing the user to rent and/or purchase the selected item; and,
providing the selected item to the user.

9. The computer program product according to claim 8, wherein the operations further comprise
performing at least one of the following: returning the selected item after expiration of the desired rental period and renewing the desired rental period.

10. The computer program product according to claim 8, wherein the purchase price is determined based on the rental cost.

11. The computer program product according to claim 8, wherein the operations further comprise
generating a wait list to allow the user to include the selected item that may be currently unavailable for rental and/or purchase;
adding the selected item to generated wait list;
requesting a notification indicating when the selected item is available.

12. The computer program product according to claim 8, wherein the operations further comprise
generating a wish list to allow the user to include the selected item that is currently available for rental and/or purchase;
adding the selected item to the generated wish list as an item that the user may wish to rent and/or purchase at a future time.

13. The computer program product according to claim 8, wherein the operations further comprise
selecting one or more items in the plurality of items;
combining the selected one or more items into a package for rental and/or purchase at a first price.

14. The computer program product according to claim 8, wherein the operations further comprise
providing an incentive to the user to rent and/or purchase the selected item.

15. A system comprising:
at least one programmable processor; and
a machine-readable medium storing instructions that, when executed by the at least one programmable processor, cause the at least one programmable processor to perform operations comprising:
selecting an item in the plurality of items;
determining at least one parameter relating to the selected item and including at least a type of the selected item;
determining whether a user desires to rent and/or purchase the selected item;
if the user desires to rent the selected item,
determining whether the selected item is available for rent,
determining a desired rental period during which the selected item is rented out to the user,
determining a rental cost of the selected item to the user based on the determined rental period,
determining whether the user desires to extend the rental period of the selected item, and
determining whether the user wishes to purchase the selected item after expiration of the rental period of the selected item;
determining whether the user desires to purchase the selected item and determining a purchase price of the selected item;
authorizing the user to rent and/or purchase the selected item; and,
providing the selected item to the user.

16. The system according to claim 15, wherein the operations further comprise
performing at least one of the following: returning the selected item after expiration of the desired rental period and renewing the desired rental period.

17. The system according to claim 15, wherein the purchase price is determined based on the rental cost.

18. The system according to claim 15, wherein the operations further comprise
generating a wait list to allow the user to include the selected item that may be currently unavailable for rental and/or purchase;
adding the selected item to generated wait list;
requesting a notification indicating when the selected item is available.

19. The system according to claim 15, wherein the operations further comprise
generating a wish list to allow the user to include the selected item that is currently available for rental and/or purchase;
adding the selected item to the generated wish list as an item that the user may wish to rent and/or purchase at a future time.

20. The system according to claim 15, wherein the operations further comprise
selecting one or more items in the plurality of items;
combining the selected one or more items into a package for rental and/or purchase at a first price.

21. The system according to claim 15, wherein the operations further comprise
providing an incentive to the user to rent and/or purchase the selected item.
